(19) United States
(12) Patent Application Publication
(10) Pub. No.: US 2019/0101641 A1
(43) Pub. Date: Apr. 4, 2019

(54) WORK TOOL COLLISION AVOIDANCE SYSTEM FOR UNDERGROUND OBJECTS

(71) Applicant: Caterpillar Paving Products Inc., Brooklyn Park, MN (US)

(72) Inventors: Lee M. Hogan, Varna, IL (US); David Nels Peterson, Brooklyn Park, MN (US); Timothy Michael O'Donnell, Long Lake, MN (US); Eric Engelmann, Delano, MN (US)

(73) Assignee: Caterpillar Paving Products Inc., Brooklyn Park, MN (US)

(21) Appl. No.: 15/724,577

(22) Filed: Oct. 4, 2017

(51) Int. Cl. G01S 13/93; E02F 9/26; E02F 9/24

(52) U.S. Cl. CPC G01S 13/931; E02F 9/264; B60Y 2200/41; E02F 9/262; E02F 9/245

(57) ABSTRACT

An electronic controller comprises a memory including computer executable instructions for detecting an underground object, and a processor coupled to the memory and configured to execute the computer executable instructions, the computer executable instructions when executed by the process cause the processor to: sense a signal indicating the presence of an underground object, and send a control signal to a machine control system or a work tool control system to alter the movement of the machine or the work tool.

### TECHNICAL FIELD

The present disclosure relates to machines such as earth moving, mining, milling machines such as cold planers, construction machines and the like that use work tools to manipulate material such as soil, asphalt, concrete, etc. More specifically, the present disclosure relates to such machines that use a work tool collision avoidance system that helps a machine to stop or alter the movement of a work tool or the machine before the work tool comes into contact with an underground object.

### BACKGROUND

Machines are routinely used in the earthmoving, construction, mining and paving industries for moving or manipulating material. In particular, in the paving industry, milling machines such as cold planers are used. These machines are used for various purposes and therefore employ a host of different work tools. In many cases, these machines utilize work tools such as rotary cutting tools, buckets, rakes, etc. that manipulate or disturb soil, asphalt, rocks, concrete, etc. As can be imagined, these work tools may occasionally come into contact with underground objects such as large rocks that may cause damage to the work tool, necessitating repair or replacement of the work tool or the working portions of the work tool such as teeth, tools, tool or teeth holders, cutting edges, etc. Or, in some cases, the underground object such as cables, wires, pipelines, etc. may be sensitive to damage caused by the work tool. This may necessitate that these underground objects be repaired should they be damaged. In either scenario, the damage could stop work in the area where the damage has occurred, leading to loss time and profit for the particular economic endeavor being performed in the area.

For example, rotary tools such as cutting drums are routinely employed by milling machines such as cold planers and the like for ripping up a work surface such as soil, loose rock, asphalt, pavement, concrete, etc. As can be imagined, these rotary tools may use cutting bits adapted to perform the necessary work. These cutting bits are subject to wear. Therefore, it is often necessary to replace these cutting bits once worn. Alternatively, it may be desirable to change out one type of cutting bit for another type of cutting bit depending on the work material. For example, one cutting bit may be well adapted for ripping up concrete while another may be better suited for ripping up asphalt.

Accordingly, it is desirable to prevent such damage to underground objects or damage to work tools that may contact such underground objects before the damage occurs.

### SUMMARY OF THE DISCLOSURE

A method for avoiding objects is provided according to an embodiment of the present disclosure including transmitting a signal using a sensor of a machine, the sensor being positioned in front of a work tool of the machine and along a direction of travel of the work tool or the machine, the machine traveling along a path on a ground surface and the work tool is moving, the sensor pointing toward the ground surface, monitoring signals responsive to the signal transmitted using the sensor, the signals being monitored using the sensor or a receiver from the sensor, processing one or more of the signals to detect an object along the path, comparing a distance between the object and the work tool, to a threshold, and at least one of altering a movement of the work tool based on comparing the distance to the threshold, or altering a movement of the machine based on comparing the distance to the threshold.

A work tool collision avoidance system for a machine with a work tool, according to an embodiment of the present disclosure, comprises a sensor, a receiver, and an electronic controller unit coupled to the sensor and the receiver. The electronic controller unit is configured to cause the sensor to transmit a signal at a first time interval, process a signal received by the receiver at a second time interval, and alter the movement of the work tool or machine after processing the signal received by the receiver.

An electronic controller unit according to an embodiment of the present disclosure is provided. The electronic controller unit may comprise a memory including computer executable instructions for detecting an underground object, and a processor coupled to the memory and configured to execute the computer executable instructions, the computer executable instructions when executed by the process cause the processor to: sense a signal indicating the presence of an underground object, and send a control signal to a machine control system or a work tool control system to alter the movement of the machine or the work tool.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a perspective view of a machine such as a cold planer utilizing a work tool collision avoidance system for underground objects according to an embodiment of the present disclosure.

FIG. 2 is a side view of the machine of FIG. 1.

FIG. 3 is a perspective view of a work tool in the form of a rotary cutting assembly that is used by the machine of FIG. 1.

FIG. 4 contains a schematic block diagram of the work tool collision avoidance system of the machine of FIG. 1 according to an embodiment of the present disclosure.

FIG. 5 contains a schematic block diagram of a sensor array that may be used by the work tool collision avoidance system of FIG. 4.

FIG. 6 is a flow chart describing a method implemented by the work tool collision avoidance system of FIG. 4.

FIG. 7 contains a schematic block diagram illustrating how the electronic controller unit of the work tool collision avoidance system of FIG. 4 may be configured.

FIG. 8 contains a schematic block diagram depicting how a processor executes a set of computer executable instructions that may be used by the work tool collision avoidance system of FIG. 4.

FIGS. 9 thru 15 are screenshots of the GUI that may be provided by the work tool collision avoidance system of FIG. 4, showing the various functions of the GUI (Graphical User Interface) and the system.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

In various embodiments, a method that may be implemented by a work tool collision avoidance system for objects (e.g. underground objects and above ground objects), the work tool collision avoidance system itself, and an electronic controller unit that is configured to implement the method or be used with the work tool collision avoidance system may be provided and will now be described.

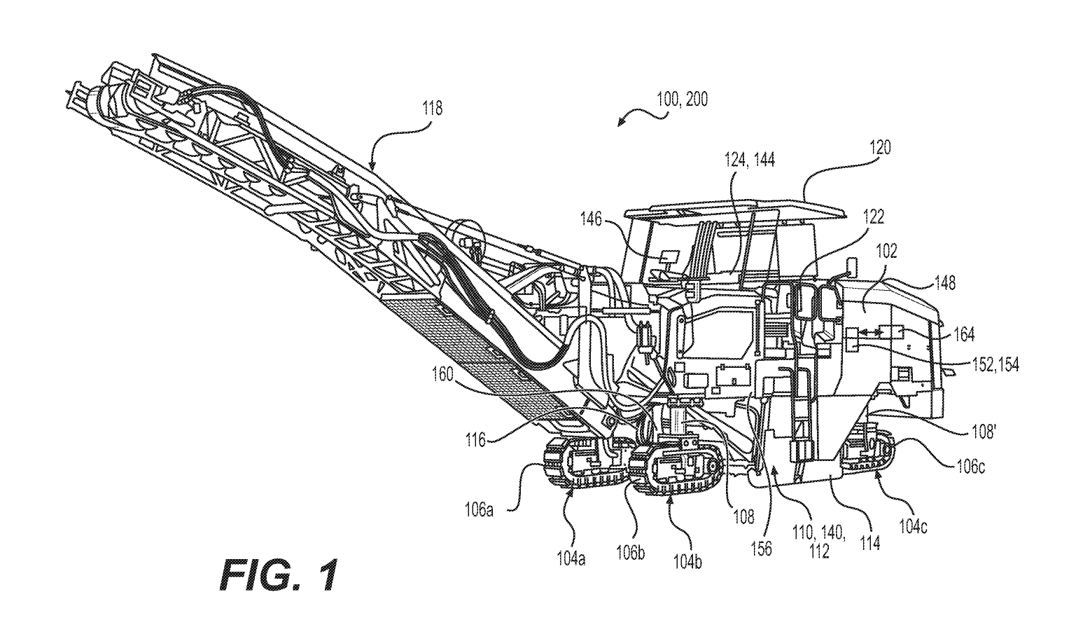

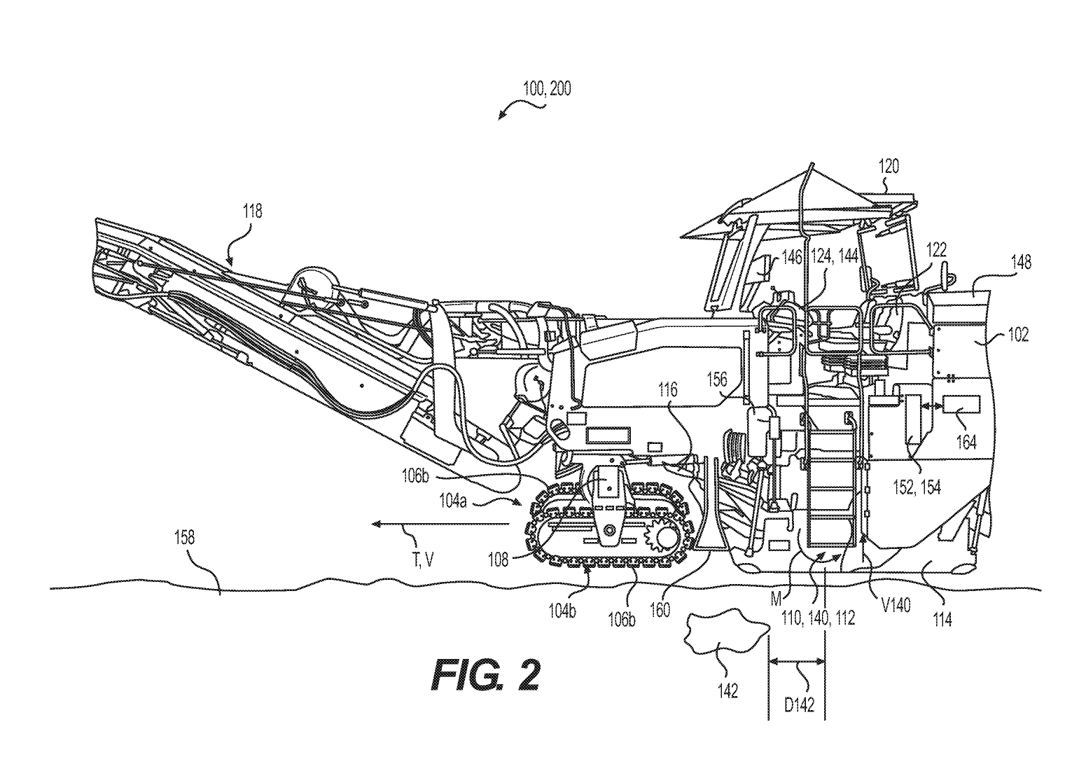

FIGS. 1 and 2 illustrate an exemplary machine 100 having multiple systems and components that cooperate to accomplish such a task. Machine 100 may more generally embody a mobile machine that performs some type of operation associated with an industry such as mining, construction, farming or agriculture, transportation, earth moving, paving and/or the like. As just mentioned, machine 100 may be a milling machine such as a cold planer. Machine 100 may include a power source 102 and one or more undercarriage assembly 104, which may be driven by power source 102.

Power source 102 may drive the undercarriage assembly(s) 104 of machine 100 at a range of output speeds and torques. Power source 102 may be an engine such as, for example, a diesel engine, a gasoline engine, a gaseous fuel-powered engine, or any other suitable engine. Power source 102 may also be a non-combustion source of power such as, for example, a fuel cell, a power storage device, and/or the like.

Undercarriage assembly(s) 104 may include crawler tracks 106. The undercarriage assemblies 104 may be attached to the machine 100 via hydraulic cylinders 108 that may be raised or lowered or rotated to position the machine 100 both vertically or horizontally at a desired position relative to a work surface. Other types of undercarriages may be employed such as those employing wheels, walking mechanisms, etc.

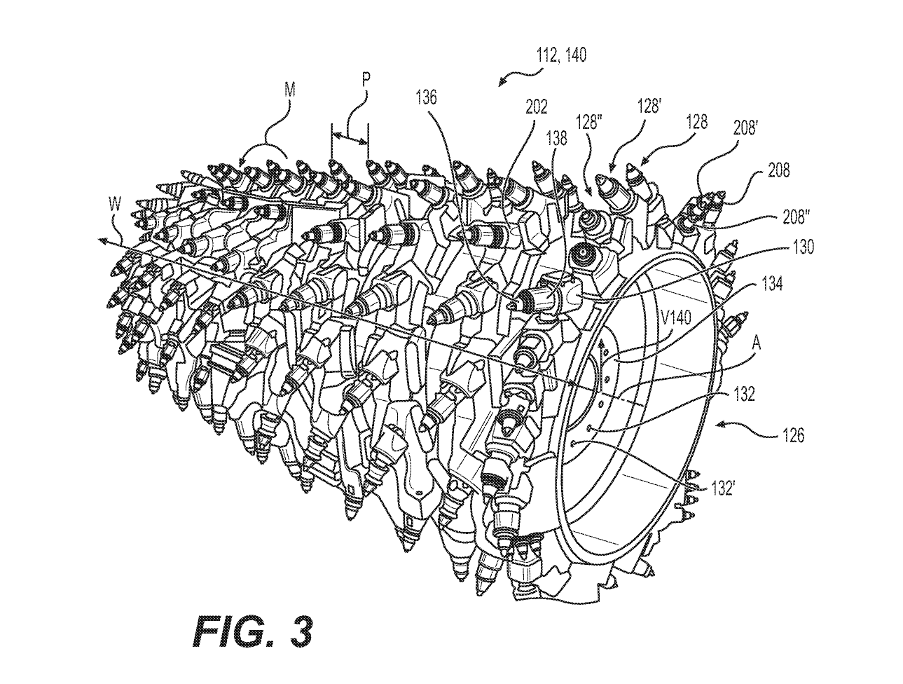

An implement assembly 110, which includes a rotary cutting drum assembly 112 (best seen in FIG. 3), is shown to be attached to and extend from the bottom of the machine 100 in FIGS. 1 and 2 such that it can hover a desired distance above the ground 158 (as used herein “ground” is to be understood to include pavement, concrete, dirt, soil, rocks and/or any other type of work surface). The implement assembly 110 includes two hydraulic side plates 114 (only one of which is shown in FIGS. 1 and 2 but it is to be understood that a similar side plate is on the opposite side of the machine) with position sensors (not shown) used to monitor and position the rotary cutting drum assembly 112 (shown in FIG. 3). A cover plate (not shown in FIG. 1 or FIG. 2) extending between the side plates 114 is often employed to partially surround the rotary cutting drum assembly 112, being positioned above and to the rear of the cutting drum. A transmission (not shown in FIGS. 1 and 2) may be operatively connected to the power source 102 and the rotary cutting drum assembly 112, allowing the power source 102 to drive the rotary cutting drum assembly 112 to rotate and rip up the ground (or otherwise manipulate or process the ground).

As shown in FIGS. 1 and 2, the implement assembly 110 is fitted with hydraulic hoses 116 to feed water that is sprayed onto the rotary cutting drum assembly 112, helping to remove debris from the rotary cutting drum assembly 112 in use. This debris is diverted by the machine 100 to a foldable conveyor system 118 that transports the material to another vehicle or dump site where the discarded material is hauled away from the work area.

An operator cab (or operator cabin) 120 is also shown that houses a seat 122 and controls 124 for the operator to use to control the various functions of the machine 100. The configuration of this machine as well as the implement assembly 110 may be varied as needed or desired. The machine of FIGS. 1 and 2 is provided by way of an example only as other types of machines are considered to be within the scope of the present disclosure.

Looking now at FIG. 3, the rotary cutting drum assembly 112 includes a substantially cylindrical drum member 126 defining an axis of rotation A and an axial width W with a plurality of cutting tool assemblies 128 attached to the drum member 126 about its circumference in a manner known in the art. For example, the cutting tool assemblies 128 may have a block or base 130, which is welded or otherwise adhered or fastened to the drum member 126. It is contemplated that the base 130 may be formed integrally with the drum member 126, having a unitary construction with the drum member 126. A series of bolt holes 132 are shown on the hub 134 of the drum member 126 that are used to attach the cutting drum member 126 to the implement assembly 110. The cutting tool assemblies 128 are shown to be attached to the cutting drum member 126 along a spiral or helical path about the circumference of the drum member 126 with the cutting tool bit 136 of each cutting tool assembly 128 extending at a slightly different angle of attack than the adjacent cutting tool assembly 128′ along the spiral path. It is contemplated that the arrangement, configuration, and angle of attack of each of the cutting tool assemblies may be varied as needed or desired. The cutting tool assembly 128 includes a base 130, which is usually attached to the drum member 126 as previously described, a tool adapter 138 that may be attached and detached from the base 130, and a cutting tool bit 136 that may be attached and detached from the tool adapter 138.

The axial width W of the rotary cutting drum assembly 112 may vary depending on the application but may be approximately 18 inches to 88 inches depending on the application. Accordingly, as will be described in further detail later herein, the number and configuration of sensors used to detect underground objects may be varied as needed or desired based on one or more dimensions of the rotary cutting drum assembly 112. For example, the sensors may be positioned relative to each other so that an appropriate amount of sensitivity, accuracy and/or resolution may be provided between the sensors along the axial width W of the rotary cutting drum assembly 112 such that any object (underground and/or above ground) may be effectively detected. Similarly, the sensors may be positioned relative to the axial end of the drum so that the axial end of the rotary cutting drum member 126 may avoid contacting an object. For example, the distance from one cutting bit 128 to an adjacent cutting bit 128 may be defined by a pitch P. When a spiral or helical pattern is used for the arrangement of the cutting bits 128 about the circumference of the drum member 126, the pitch P is the height of one complete helix turn, measured parallel to the axis A of the helix. In some embodiments, the distance from one sensor to the next as will be described may be a function of the pitch P, so that each cutting bit is suitably protected by the ability of the sensors to detect an object.

In use, the rotary cutting drum assembly 112 breaks up the ground such as rock, dirt, pavement, concrete, asphalt, etc. In some cases, an object may be present and may be damaged by the rotary cutting drum assembly 112 or may damage the rotary cutting drum assembly 112, necessitating maintenance. For example, the tool adapter 138, tool bit 136, and or base 130 may need to be replaced or fixed, etc. Accordingly, a work tool collision avoidance system 200 may be provided as will now be described.

FIGS. 1 and 2 illustrates a work tool collision avoidance system 200 used on the machine 100, in accordance with an embodiment of the present disclosure. The apparatus includes a machine 100 and a work tool 140 in an exemplary work environment. It will be appreciated that the work tool collision avoidance system 200 may include a plurality of machines and a plurality of work tools and the machine 100. Thus, the work tool 140 illustrated in FIGS. 1 thru 3 are by way of example only and not by way of limitation. Further, the work tool collision avoidance system 200 may include additional components, including but not limited to, a base station in communication with the machine 100, a satellite system in communication with the machine 100, an unmanned aerial vehicle in communication with the machine 100, and the like, to assist recognition and/or monitoring of the movement of the work tool 140 and machine 100 relative to underground object 142. Accordingly, the systems controlling the machine may not be on the machine itself but may be located remotely from the machine.

The machine 100 may be a movable machine or a stationary machine having movable parts. In this respect, the term “movable” may refer to a motion of the machine 100, or a part thereof, along linear Cartesian axes, and/or along angular, cylindrical, or helical coordinates, and/or combinations thereof. Such motion of the machine 100 may be continuous or discrete in time. For example, the machine 100, and/or a part of the machine 100, may undergo a linear motion, an angular motion or both. Such linear and angular motion may include acceleration, rotation about an axis, or both. By way of example only and not by way of limitation, the machine 100 may be an excavator, a paver, a dozer, a skid steer loader (SSL), a multi-terrain loader (MTL), a compact track loader (CTL), a compact wheel loader (CWL), a harvester, a mower, a driller, a hammer-head, a ship, a boat, a locomotive, an automobile, a tractor, or other machine to which the work tool 140 is attachable.

In the example shown in FIGS. 1 and 2, the machine 100 is a cold planer as previously described. The operator cab 120 includes, among other components, a steering system 144 to guide the machine 100 in various spatial directions, and an output device 146. The operator cab 120 may be suitably sized to accommodate a human operator. Alternatively, the machine 100 may be controlled remotely from a base station, in which case, the operator cab 120 may be smaller. The steering system 144 may be a steering wheel or a joystick, or other control mechanism to guide a motion of the machine 100, or parts thereof. Further, the operator cab 120 may include levers, knobs, dials, displays, alarms, etc. to facilitate operation of the machine 100.

Under the hood 148, the machine 100 includes an electronic controller unit 150 (may also be referred to as an electronic control module or “ECM”), a machine control system 152, and possibly a work tool control system 154. The machine 100 may include other components (e.g., as part of the chassis 156) such as transmission systems, engine(s), motors, power system(s), hydraulic system(s), suspension systems, cooling systems, fuel systems, exhaust systems, ground engaging tools, anchor systems, propelling systems, communication systems including antennas, Global Positioning Systems (GPS), and/or the like (not shown) that are coupled to the machine control system 152.

By way of example only and not by way of limitation, the work tool 140 may be coupled in a movable manner to the machine 100. Mechanical linkages, hydraulic or pneumatic cylinders, a transmission, etc. may make the work tool be extendable, expandable, contractible, rotatable, and translatable radially or axially, or otherwise movable by the machine 100. For example, a height and a tilt of the work tool 140 may be variable to adjust the position of the work tool 140 relative to the ground 158. Once attached to the machine 100, the work tool 140 may be configured to receive requisite power from the machine 100 to perform various operations (e.g., digging earth, breaking ground) in the exemplary worksite using the work tool 140.

In some embodiments of this disclosure, the sensor 160 may be a ground penetrating radar unit attached to the machine 100. This ground penetrating radar unit may be positioned on, inside, or above the operator cab 120 (not shown in FIGS. 1 and 2). Alternatively, or additionally, the sensor 160 may be a ground penetrating radar unit positioned next to and in front of the work tool 140 along a direction of the travel T of the machine 100. Such a sensor 160 may be provided before and/or aft of the work tool 140 along the direction of travel T, allowing the machine 100 to move forwards or backwards and still be able to sense the presence of an object 142 (e.g., underground and/or above ground) before the work tool 140 strikes the object 142. The sensor 160 may be configured to move in like manner as the work tool 140, as previously described, so that the sensor 160 may track, mimic or follow the movement or position of the work tool 140, allowing the sensor to effectively monitor the ground proximate the work tool 140. For example, the sensor 160 may be attached directly to the work tool 140 or indirectly via the chassis 156 or may be controlled by the same control system 152, 154 as the work tool 140 so that the position of the sensor 160 remains consistent relative to the work tool 140.

As shown in FIGS. 1 and. 2, the sensor 160 may be positioned near the midplane of the machine 100 along a direction perpendicular to the view of FIG. 2, while also being positioned between the rotary cutting drum assembly 112 and the tracks 106 of the machine 100 along the direction of travel T. By way of example only and not by way of limitation, the sensor 160 may be an infrared camera, an opto-acoustic sensor, an ultrasound or infrasound sensor, a radar, a laser based imaging sensor, a radio antenna or receiver, Bluetooth device, and/or the like, or combinations thereof, configured to assist recognition, detection, tracking, and avoiding contacting underground objects 142 or above ground objects. As illustrated in FIG. 2, a sensor 160 in the form of a ground penetrating unit is provided near the ground that acts both as a transmitter and a receiver 162. In some embodiments, it is contemplated that a separate transmitter and receiver may be provided.

The work tool 140 is attachable to the machine 100, and may be a bucket, a rotary cutting assembly 112, a harvester attachment, a drill head, a hammer head, a compactor head, or any other type of implement attachable to any type of machine 100 used to manipulate the ground 158. In this respect, the machine 100 may be configured to be attachable not just to one type of the work tool 140, but also to different types of the work tool 140, as well as to a plurality of work tools at the same time.

With continued reference to FIGS. 1 and 2, depending on the type of work tool 140 being utilized, the machine 100 may be configured to operate in an output mode specific to the type of the work tool 140. An output mode of the machine 100 is specified by appropriate electrical and mechanical parameters for operation of the work tool 140 when attached to the machine 100. For example, an output mode for a bucket is different from an output mode of a rotary cutting drum assembly 112 in terms of an output power delivered to the work tool 140. If an incorrect output mode is selected, or if no output mode is selected by a manual operator when the work tool 140 is attached to the machine 100, the machine may not be able to properly perform, or not perform, the job for which the machine 100 was deployed.

In one aspect, the work tool 140 may be stationary. In another aspect, the work tool 140 may be mobile or movable towards or relative to the machine 100. For example, another machine (not shown) may be used to push the work tool 140 to match a motion of the machine 100 and/or of the machine component. Also, as will be explained in further detail later herein, using an input device such as the controls described earlier herein or a HMI (Human Machine Interface) or a GUI (Graphical User Interface), the type of work tool being used may be selected, altering the work tool collision avoidance system 200 on where or how to look for underground objects 142 relative to the work tool 140 or to the machine 100.

In some embodiments of the present disclosure, the machine control system 152 may include various hydraulic and electrical power systems controlled by the electronic controller unit 164, based upon output signals from the electronic controller unit 164 to the machine control system 152. The machine control system 152 may include or may be coupled to the steering system 144 configured to guide, alter or stop a motion of the machine 100. The machine control system 152 may include or be separate from a work tool control system 154 that may also be used to guide, stop, or alter the motion of the work tool 140 relative to the machine 100 or the ground 158. In another aspect, the machine control system 152 and/or work tool control system 154, or a part thereof, may be located remote from the machine 100, e.g., in a base station physically separated from the machine 100. In this scenario, the machine control system 152 and/or work tool control system 154 may have a direct or indirect communication link with the electronic controller unit 164 to control the machine 100 and/or the work tool 140. Various operative communication between the machine control system, work tool control system and the steering system may be omitted in other embodiments.

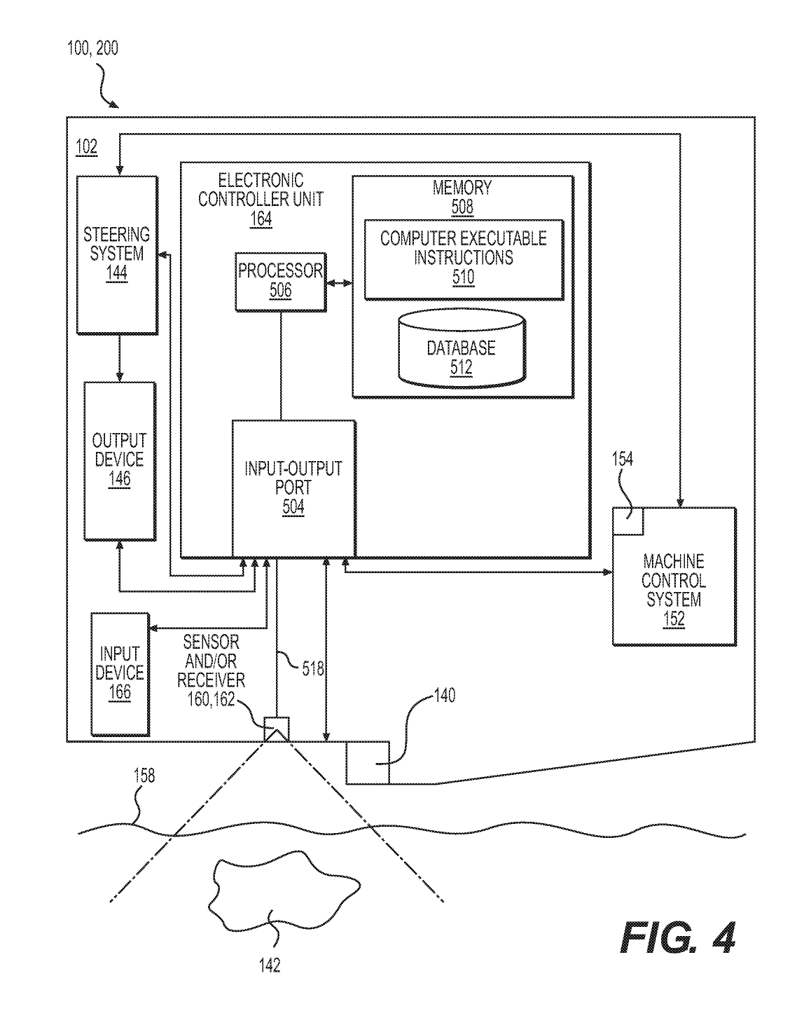

Referring to FIG. 4, a schematic diagram of the work tool collision avoidance system 200 with the machine 100 including the electronic controller unit 164 is illustrated, in accordance with an embodiment of the present disclosure. The electronic controller unit 164 is coupled to the sensor 160, the machine control system 152, the work tool control system 154, the output device 146, and the steering system 144, as well as to other components of the machine 100 (not shown).

In some instances, the machine 100 and/or work tool 140 may approach an object 142 that cannot be seen by an operator. As the machine and/or work tool moves toward the object 142, the work tool 140 may contact the object, causing damage to either the work tool or the object. This may require maintenance and a halt to the economic endeavor being conducted in the work area.

To address this issue, the electronic controller unit 164 may continuously receive an input signal 518 from the sensor 160 at an input-output port 504 of the electronic controller unit 164 and may process that signal 518 to detect the presence of an underground object 142 before the work tool 140 contacts that object.

In some embodiments of the present disclosure, the electronic controller unit 164 includes the input-output port 504, a processor 506, and the memory 508 coupled to each other, for example, by an internal bus (not shown). The electronic controller unit 164 may include additional components, which components are not explicitly illustrated in FIG. 4. For example, the electronic controller unit 164 may include a programmable logic circuit (PLC), a timer/clocking circuit, heat sinks, visual indicators (e.g., light emitting diodes), impedance matching circuitry, internal buses, co-processors or monitor processors, batteries and power supply units, power controller chips, transceivers, wireless modules, satellite communication processing modules, and embedded systems on various integrated chips. In one embodiment, the electronic controller unit 126 may be separate from an engine controller unit (not shown). In an alternative embodiment, the electronic controller unit 164 may be integrated with or may share space and processing resources with the engine controller unit.

The input-output port 504 may be a single port or a collection of ports. The input-output port 504 is configured to transmit and receive various inputs and data from other parts of the machine 100 and forward such inputs and data to the processor 506. In one aspect, the input-output port 504 may be two separate ports, one configured to receive various input signals from various parts of the machine 100 (e.g., the sensor 160, etc.) and another configured to output signals for display (e.g., on the output device 146) or for control of the machine 100 (e.g., to the machine control system 152) or control of the work tool (e.g., to the work tool control system 154). Alternatively, the functionalities of inputting and outputting may be integrated into a single port illustrated as the input-output port 504 in FIG. 4.

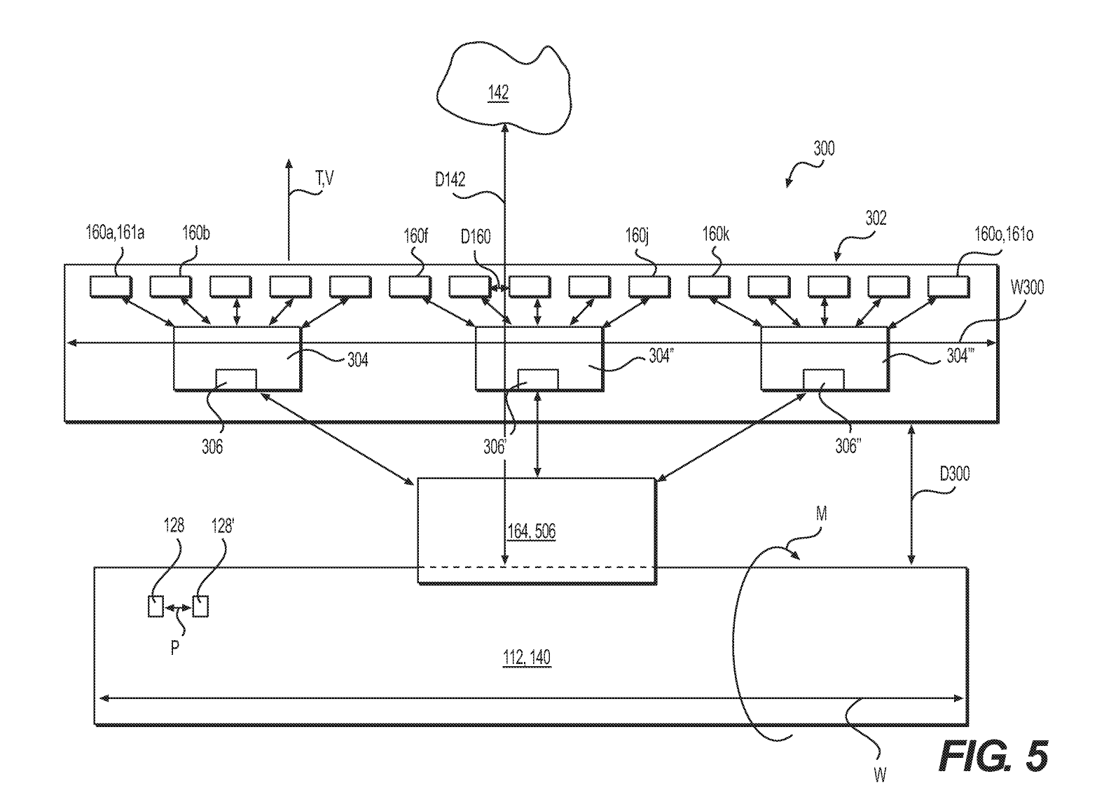

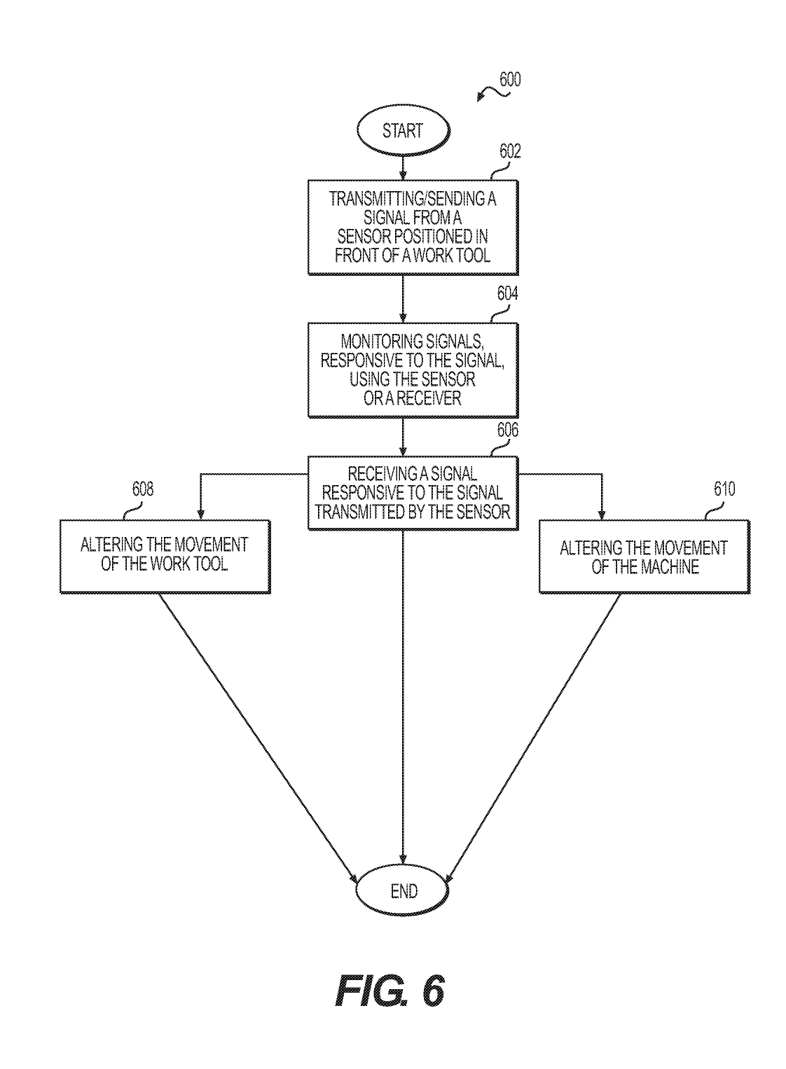

In one aspect, the processor 506 is a hardware device such as an integrated circuit (IC) chip fabricated to implement various features and functionalities of the embodiments discussed herein. By way of example only and not by way of limitation, the processor 506 may be fabricated using a Complementary Metal Oxide Semiconductor (CMOS) fabrication technology. In one embodiment, the processor 506 may be implemented as an Application Specific Integrated Circuit (ASIC), a Field Programmable Gate Array (FPGA), a System-on-a-Chip (SOC), or the like. In another embodiment, the processor 506 may include components such as packaging, input and output pins, heat sinks, signal conditioning circuitry, input devices, output devices, processor memory components, cooling systems, power systems and the like, which are not shown in FIG. 4. In one particular embodiment, the processor 506 is configured to execute various parts of a method illustrated in FIGS. 5 and 6 by executing computer executable instructions 510 in the memory 508. In yet another embodiment, the processor 506 may be a plurality of processors arranged, for example, as a processing array.

The memory 508 may be implemented as a non-transitory computer readable medium. By way of example only, the memory 508 may be a semiconductor based memory device including but not limited to random access memory (RAM), read only memory (ROM), Dynamic RAM, Programmable ROM, Electrically Erasable programmable ROM (EEPROM), Static RAM, Flash memory, combinations thereof, or other types of memory devices known to one of ordinary skill in the art. In one embodiment, the memory 508 is coupled to the processor 506 directly via a communication and signal bus. In one embodiment, the memory 508 may be made of or implemented using a non-transitory computer readable storage medium on which the computer executable instructions 510 reside. The computer executable instructions 510 when executed by the processor 506 cause the processor 506 to carry out the features and functionalities of the various aspects of this disclosure, such as those discussed with respect to FIGS. 5 thru 8. Such non-transitory computer readable storage medium may include semiconductor memory, optical memory, magnetic memory, mono- or bistable circuitry (flip-flops, etc.) and the like, or combinations thereof. Such non-transitory computer readable storage medium excludes signals that are transitory.

The computer executable instructions 510 may be executed by the processor 506 using high-level or low-level compilers and programming languages (e.g., C++). In one embodiment, the computer executable instructions 510 may be executed remotely by a base station, and results of such execution provided to the processor 506 for controlling the work tool vision system. In this respect, it will be appreciated that the specific location of the computer executable instructions 510 inside the memory 508 is by way of example only, and not by way of limitation.

In some embodiments, the memory 508 includes or is coupled to a database (or a data structure) 512. The database 512 includes signal templates (or information regarding signals) for various objects (underground and/or above ground). Such signal templates are saved as a library of files and computerized models in the database 512. Such templates may include radar based images or tables linking the data encoded in received signals to different types of objects. For example, the received signal may give a code via amplitude or frequency modulation that matches the object to the signal. More specifically, the sensor may transmit an activation signal that causes the underground object to generate an identifying signal in response to the activation signal or that is reflected from the object after being transmitted by the sensor. In other cases, the type of underground object may be indicated by the properties of the reflected radar signal, etc. which is matched up to a table linking the type of reflected signal to the properties of the object. Activation signals may also be sent to the object via direct communication, induction or other methods. For example, electrical current may be applied to a pipeline or a utility line creating a magnetic or an electrical field that may be received by the sensor 160.

The database may contain other information such as various responses or actions to be taken if an object 142 (underground or above ground that may contact and/or cause damage to the work tool 140) are detected. As shown in FIGS. 2, 3 and 5, various variables may be taken into account when determining the desired or appropriate action such as the distance D142 of the work tool 140 to the object 142, the vehicle speed V, the movement M of the work tool 140, and/or the speed V140 at which the work tool 140 may be moved, such as raised relative to the ground 158, to avoid contacting the object 142.

Returning to FIG. 4, the processor 506 may be able to generate an image of the underground object and send that image to a display (i.e. output device 146). Alternatively, the output device 146 could be an alarm, a flashing light, etc. Such images and information may be continuously accessible to the processor 506 before, during, and after the underground object 142 has been detected. This may be used to indicate, to an operator or an operational system that a certain area is off limits until the presence of the underground object has been addressed.

It will be appreciated that the output device 146 may continuously display an image of the underground object 142 on a frame-by-frame basis as provided by the processor 506 to the output device 146 based upon the input signals (including the input signal 518) from the sensor 160 as modified by the processor 506. In one aspect, the images may be provided on a display of a remote operator of the machine 100 in a remote base station (not shown) as a real-time video of the work scene in which the machine 100 and the work tool 140 are deployed. In other applications, the output device 146 may be located in the cab 120 of the machine 100 as shown in FIG. 2 where the operator may see how the work tool 140 is moving relative to the underground object 142 or the machine 100.

A plurality of machines 100 may be interconnected forming a network via the base station and/or satellites as previously alluded to herein, etc. For example, one machine may detect an underground object 142 and transmit, to another machine 100′, information regarding the detected object 142 to enable and/or cause the other machine to properly adjust the drum 126 and/or navigate around the object 142. In some cases, a central control system at the base station may directly command the other machine 100′ with respect to drum control and/or navigation based on the information regarding the detected object 142.

As illustrated in FIG. 5, in some embodiments, the sensor 160 may take the form of a sensor array 300 that is part of a sensor bar 302 including a plurality of sensors 160 arranged along the axial width W of a rotary cutting drum assembly 112 or other work tool 140. For example, for a rotary cutting drum assembly 112 that is very wide (e.g. 80 inches to 88 inches (or 2.0 m to 2.2 m) for the axial width W), fifteen sensors 160 or antennas 161 may be provided that are evenly spaced along the width W of the work tool 140. The sensor array 300 may define a sensor array width W300 that may be greater than or equal to the width W of the work tool 140. Three digital signal processors 304 (DSP) may be provided on the sensor bar 302 that process the signals received by five of the antennas 161. In other embodiments, the digital signal processors 304 may analyze the signals from more or less antennas 161 and fewer antennas 161 may be needed for work tools 140 having a narrower width W. In some embodiments, the sensors 160 will often be directed in a direction perpendicular to the ground 158. However, this angle may be adjusted under various circumstances. For example, the ground 158 may not be level in some applications. In such a case, the angle that the sensor bar 302 makes with the vertical direction may be adjusted. This adjustment may be made manually by adjusting the sensor bar 302 by rotating the sensor bar 302 using a bolt in slot arrangement. In other instances, the sensor bar 302 may be rotated or otherwise adjusted using a motor or hydraulic cylinders that are controlled by the electronic controller unit 164. In this instance, the sensor bar 302 may be automatically adjusted by the electronic controller unit 164 detecting the various circumstances (e.g. detecting that the ground 158 is not level).

In any application, the number of sensors 160 or DSPs 304 used will be adjusted in order to provide the desired resolution, sensitivity and accuracy to prevent any portion along the width W of the work tool 140 from contacting any underground object 142. The DSPs are in communication with the processor 506 of the electronic controller unit 164 or may act as part of the processor 500 of the electronic controller unit 164. Similarly, the DSPs may be considered part of the electronic controller unit 164, being in communication therewith. To that end, the DSPs may be configured with a CANBUS chip 306 (Controller Area Network bus chip) so that they can effectively communicate with the electronic controller unit 126 of the machine 100. It is contemplated that either digital or analog radar systems may be employed in various embodiments of the present disclosure.

Various spatial relationships between the work tool 140 and the sensor array 300 are shown in FIG. 5. The distance D300 from the sensor array 300 to the work tool 140 may range as needed or desired depending on various factors such as the speed V of the machine 100 and the speed V140 for moving the work tool 140 away from the object 142. For example, the faster the speed V of the machine 100 and the slower the speed V140 for moving the work tool 140 out of the way, the larger the distance D300 may need to be. On the other hand, the slower the maximum speed V of the machine 100 and the faster the maximum speed V140, then the smaller the distance D300 may need to be in order to avoid a collision. The distance D160 between sensors 160 may be expressed as a function of the distance P between cutting tool bits 128 when the work tool 140 is a rotary cutting drum assembly 112. For example, D160 may be at least the same as P or one half of P, etc. so that the necessary resolution is provided to help prevent the cutting tool bit 128 from contacting the object 142. As alluded to earlier, the collision avoidance system 200 may be used to avoid contacting objects above and below the ground as needed or desired. Furthermore, the sensors 160 may be used to also detect the position of the work tool 140 relative to the ground as well as detect objects above or below the ground when the sensors 160 track or mimic the vertical position of the work tool 140 relative to the ground as previously described herein.

### INDUSTRIAL APPLICABILITY

In practice, a work tool collision avoidance system, an electronic controller unit or method according to any embodiment described, shown or discussed herein may be sold, bought, manufactured, remanufactured, retrofitted, assembled or otherwise obtained in an aftermarket or OEM (Original Equipment Manufacturer) context. Similarly, a machine using such a work tool collision avoidance system, an electronic controller unit or a method according to any embodiment described herein may be provided when the machine is new or when the machine is retrofitted with any of these embodiments

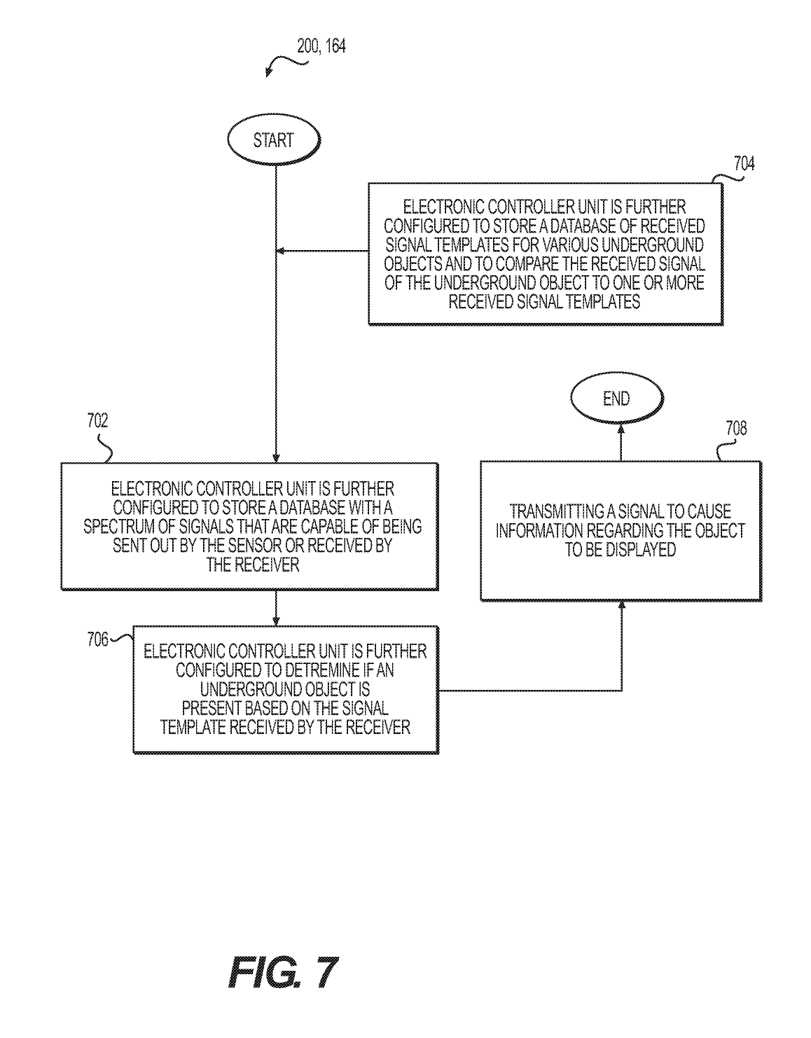

Referring back to FIG. 4 while also looking at FIG. 7, a work tool collision avoidance system 200 for monitoring for the presence of an underground object may be provided as follows. The work tool vision system 200 may comprise a sensor 160, and an electronic controller unit 164 coupled to the sensor 160, wherein the electronic controller unit 164 is configured to cause the sensor 160 to transmit a signal at a first time interval, and process a signal received by the receiver 162 at a second time interval. For example, a radar signal may be sent out or transmitted at the first time interval and then a reflected signal returning from an underground object 142 may be received at the second time interval. Also, the electronic controller unit 164 is configured to alter the movement of the work tool 140 or machine 100 after processing the signal received by the receiver 162. Altering the movement of the work tool 140 may include raising the work tool 140, stopping the rotation or other working movement of the work tool 140, etc. Raising the work tool 140 may be done by causing one or more legs of the machine 100 to be raised via hydraulic cylinders 108 or causing the work tool 140 itself to be raised. Similarly, altering the movement of the machine 100 may include stopping the movement of the machine 100, changing the course (or direction) of travel of the machine 100, etc. Similarly, the sensor bar 302 may be attached to the chassis 156 of the machine 100 and be moved up and down in like manner via the cylinders 108. In some embodiments, the sensor bar 302 may be attached to an anti-slab bar that is movable relative to the chassis 156 of the machine 100. If the anti-slab bar is in float mode, then the sensor bar 302 may be moved independently of any movement of the hydraulic cylinders 108. In other embodiments, the anti-slab bar is not in float mode and remains stationary at all times.

In many embodiments, the electronic controller unit 164 may be further configured to a store a database 512 with a spectrum or range of signals that are capable of being sent out by the sensor 160 or received by the receiver 162 (see block 702). The electronic controller unit 164 may be further configured to determine if an underground object 142 is present based on the signal template received by the receiver 162 (see block 706). In particular embodiments, the electronic controller unit 164 is further configured to store a database 512 of received signal templates for various underground objects 142 and to compare the received signal of the underground object 142 to one or more received signal templates (see block 704).

In some embodiments, the electronic controller unit 164 is further configured to change the position of the work tool 140 relative to the machine 100 or the ground 158 if an underground object 142 is detected. For example, the work tool 140 may be raised so that the work tool 140 will not contact the underground object 142. The work tool vision system 200 may further comprise an output device 132 that is in communication with the electronic controller unit 164 (see FIG. 4) and the electronic control unit 164 may be further configured to send a signal to the output device 146 that displays an image of the underground object 142.

In many embodiments, electronic controller unit 164 is further configured to indicate via the output device 146 the type of underground object 142 being detected.

The work tool vision system 200 may in some embodiment further comprise an input device 166 that is communication with the electronic controller unit 164 and the input device 166 may be configured to send a signal to the electronic controller unit 164 to affect the functioning of the work tool collision avoidance system 200. This will be described in more detail later herein with respect to a GUI that may be used to input or select functional modes.

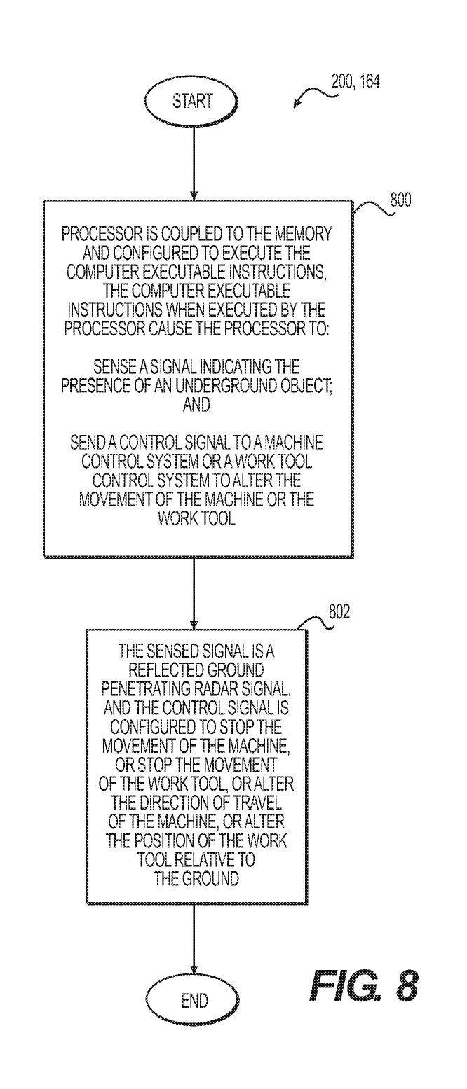

In certain embodiments, as understood looking at FIG. 4 and FIG. 8, an electronic controller unit 164 may comprise a memory 508 including computer executable instructions 510 for recognizing an underground object 142, and a processor 506 coupled to the memory 508 and configured to execute the computer executable instructions 510, and the computer executable instructions 510 when executed by the processor 506 cause the processor 506 to: sense a signal indicating the presence of an underground object 142, and send a control signal to a machine control system 152 or a work tool control system 154 to alter the movement of the machine 100 or the work tool 140 (see block 800 in FIG. 8). In many instances, the sensed signal is a reflected ground penetrating radar signal, and the control signal is configured to stop the movement of the machine 100, or stop the movement of the work tool 140, or alter the direction of travel T of the machine 100, or alter the position of the work tool 140 relative to the ground 158 (see block 802).

Focusing now on FIGS. 5 and 6, the method 600 for a work tool collision avoidance system 200 used to monitor for the presence of an underground object 142 or an above ground object according to an embodiment of the present disclosure may be described as follows. The method 800 may comprise sending a signal from a sensor 160 positioned in front of a work tool 140 (step 602), monitoring for signals using the same sensor 160 or a separate receiver 162 (step 604), and receiving a signal responsive to the signal transmitted by the sensor (step 606). In some embodiments, once the signal is received from the underground object 142, the signal received from the underground object 142 may be analyzed to determine the appropriate action or response.

In some embodiments, sending a signal includes sending ground penetrating radar waves. In such a case, the received signal may be a reflected signal.

In other embodiments, sending the signal causes the underground object 142 to send a response signal such as when marker balls are used, etc.

If a signal is received, then the method may further comprise altering the movement of the work tool 140 (step 608) or altering the movement of the machine 100 (step 610). Altering the movement of the work tool 140 may be performed automatically such as when the method 600 is performed using an electronic controller unit 164 and altering the movement of the machine 100 may also be performed automatically such as when the method 600 is performed using an electronic controller unit 164. In some cases, altering the movement of the work tool 140 or the machine 100 may be done manually after an alert has been sent to an operator. It is further contemplated that method 600 may be performed using other systems other than an electronic controller unit 164 in other embodiments.

Altering the movement of the machine 100 may include stopping the machine 100 or steering or guiding the machine 100 around the underground object 142. Altering the movement of the work tool 140 may include stopping the motion of the work tool 140 or changing the position of the work tool 140 relative to the ground 158. The signals may be processed and the appropriate action may be taken based on the movement of the work tool 140, the machine 100, based on the distance D142 and a speed V of the machine 100 to the object etc. The appropriate action may include changing the direction of the machine 100 while keeping the rotor 112 running, decelerating or stopping the machine 100 while keeping the rotor 112 running, decelerating the machine 100 while raising the rotor 112, stop the rotor 112, etc. Also, the method 600 may include comparing a distance D142 to a threshold value and altering the movement of the work tool 140 or the machine 100 based on comparing the distance D142 to the threshold value. In this regard, in some implementations, the electronic controller unit 164 may determine a deceleration rate to a threshold deceleration value, and alter the movement of the machine and/or the work tool 140.

Also, the electronic controller unit 164 may log the position of an underground object 142 relative to the work tool 140 in memory 508 (historical log). When the underground object 142 is detected, the electronic controller unit 164 may calculate the depth of the underground object 142 and/or the distance D142 from the underground object 142 to the rotor along the direction of travel T of the machine 100. Since the machine 100 will often be moving at a rate of 100 meters per minute, the distance D300 that the sensor bar 302 is positioned in front of aft of the work tool 140 may vary from one to two meters. Also, the sensor bar 302 may be positioned one to two feet above the ground 158. These dimensions allow for the needed sensitivity and reaction time to allow the ECU 164 and the machine 100 to adjust the movement of the work tool 140 and/or the machine 100. In many applications, the distance D142 from the underground object 142 to the work tool 140 along the direction of travel T may be calculated and then used in a calculation to minimize the deceleration or other movement of the machine 100 and/or the rate of movement of the work tool 140 necessary to avoid a collision. This may be useful to enhance the safety of the system 200 so that parts of the machine 100 or work tool 140 are less apt to be hit by other objects, etc.

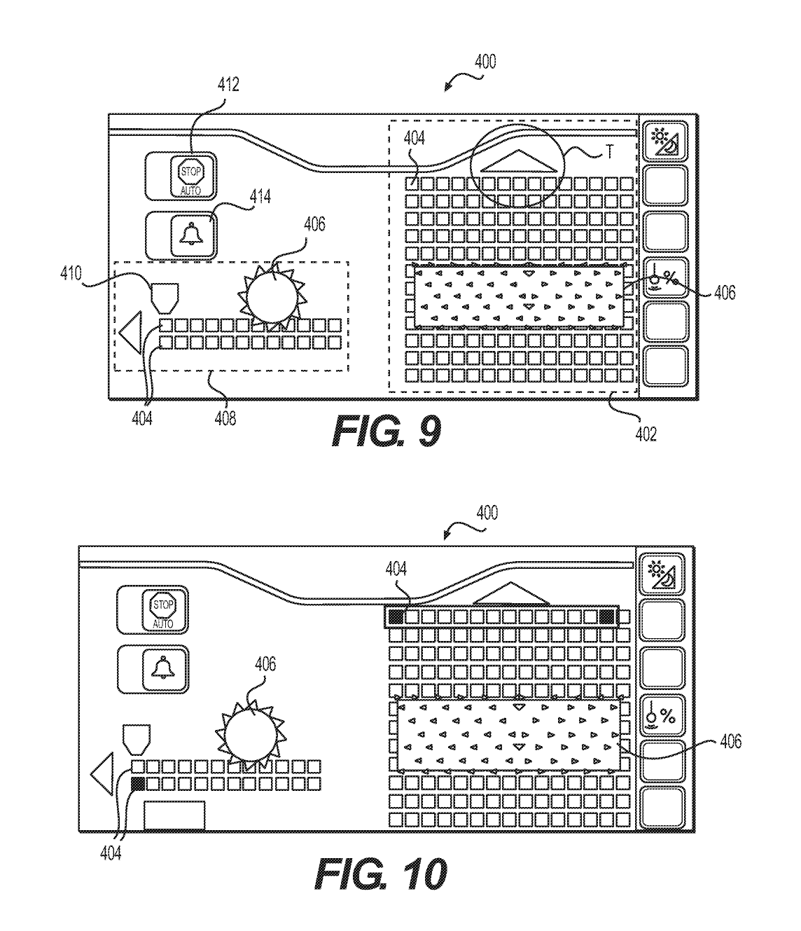

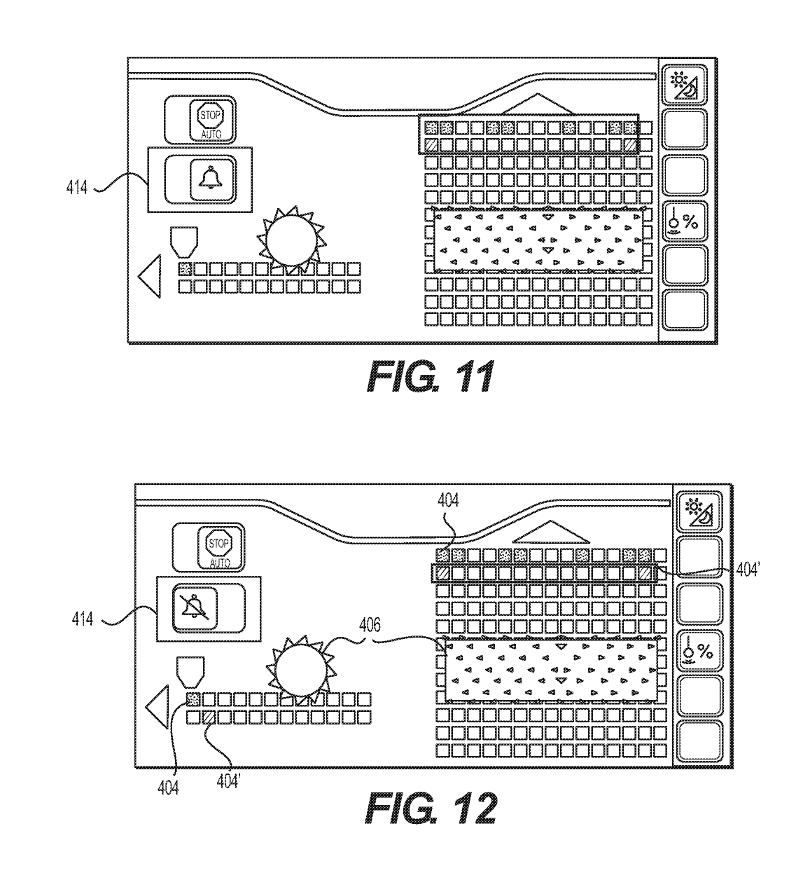

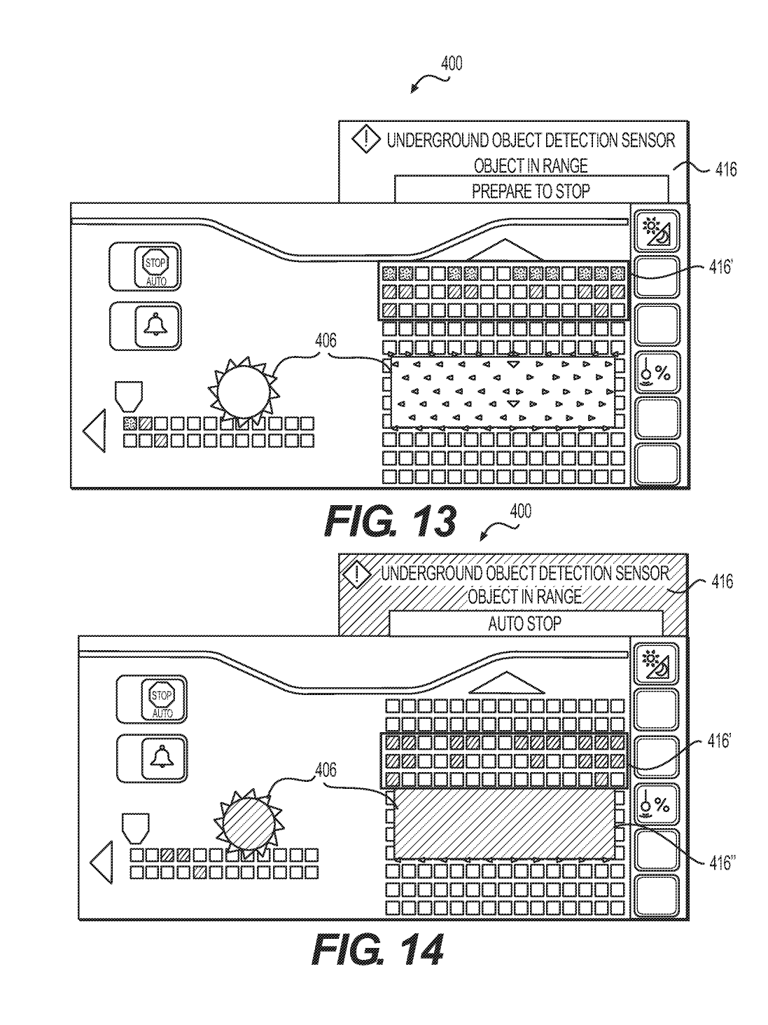

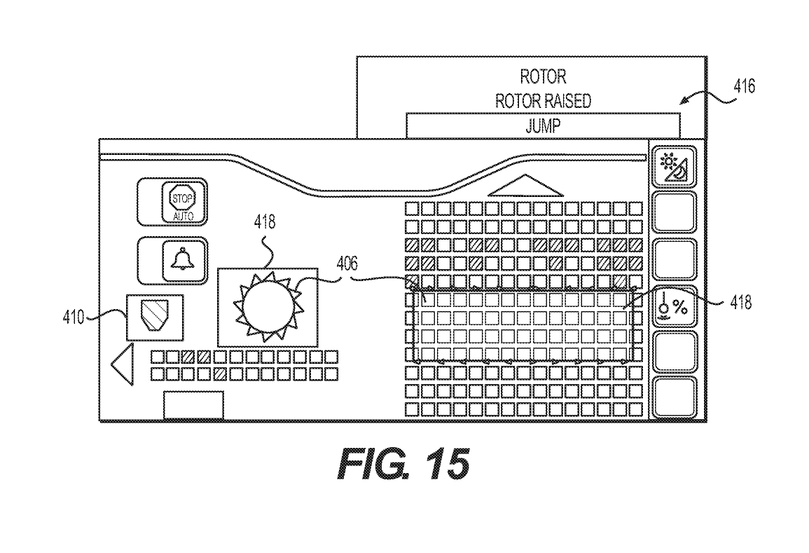

FIGS. 9 thru 15 depict a GUI that may be used with the work tool collision avoidance system 200, allowing the operator to control and use the system. Looking at FIG. 9, the GUI 400, represented by a snapshot of a screen display with touch screen interface capabilities, includes a top view portion 402 on the right side of the GUI 400, with fifteen sensor boxes 404 shown side by side representing the sensor array 300 of FIG. 5, repeated along the direction of travel T fore and aft of the rotary cutting drum assembly 406, so that that the user can see when underground objects 142 are detected ahead or aft of the rotary cutting drum assembly 406. More specifically, the distance along the travel direction T may be indicated and the axial position of the object 142 with respect to the cutting drum assembly 406 may also be detected.

Likewise, a side view portion 408 is shown on the left portion of the GUI 400, indicating the depth of the underground object relative to the rotary cutting drum assembly 406. More specifically, the top row of sensor boxes 404 indicate the cutting depth while the bottom row of sensor boxes indicates a depth below the cutting depth where the rotary cutting drum assembly 406 will not likely reach. A sensor condition pictograph 410 may be provided above the side view portion 408 that may be color coded to indicate whether the system is working properly (green color of this pictograph may indicate that the system is working). Two slide buttons are also provided so that the user may decide in what mode the system should work. The top button 412 is slid to the right, indicating that the system is in auto stop mode, making the machine 100 or work tool 140 prone to automatically change their movement to avoid colliding with an underground object 142. The bottom button 414 is also slid to the right, making the machine 100 or system 200 alert the user using visual, sound or other cues that a collision may be possibly imminent.

In FIG. 10, the axial and depth positions of an underground object 142 as detected by the system 200 are shown by the filled in sensor boxes 404. Now, the user may notice by looking at the GUI 400 that the rotary cutting drum assembly 406 is approaching the underground objects 142 but will likely not contact the objects 142 as they are too deep to cause such a collision.

In FIG. 11, the bottom button 414 is slid to the right, so an automatic alert will be issued to the operator that the rotary cutting drum assembly 406 will likely contact the underground objects, shown by the filled in sensor boxes 404 (may be filled in with the color red to indicate that a problem exists). On the other hand, sensor boxes 404′ may be filled in with a gray cross-hatch if a collision is not likely, such as when they are too deep as shown.

FIG. 12 shows the same situation as FIG. 11 except that the bottom button 414 is slid to the left, so no automatic alert will be issued to the operator that the rotary cutting drum assembly 406 will likely contact the underground objects.

FIG. 13 shows what happens when the system is in the operating mode of FIG. 11 after the machine 100 and rotary cutting drum assembly 406 advance close enough to the underground objects 142 so that a warning or an alert 416 is automatically generated by the system 200. The visual aspect of the warning or alert 416 may be color coded yellow at this time since the collision is not yet imminent.

FIG. 14 shows the situation of FIG. 13 when the travel of the machine 100 has brought the rotary cutting drum assembly 406 even closer to the underground objects 142, indicating that a collision is imminent. The visual aspect of the warning or alert 416 may be color coded red. The machine 100 and/or rotary cutting drum assembly 406 may have altered movement. For example, the machine 100 and/or rotary cutting drum assembly 406 may be stopped to avoid the collision.

Alternatively, as shown by FIG. 15, the rotary cutting drum assembly 406 may be raised relative to the ground 158, represented as a jump 418, so that the collision of the rotary cutting drum assembly 406 with the underground object 142 is avoided. The sensor 160, being attached to the machine 100 in like fashion as the rotary cutting drum assembly 406, may also be raised as shown, causing the sensor 160 to be out of range of the ground 158. So, the sensor condition pictograph 410 may be color coded yellow (sensor fault) to indicate that the sensor 160 is not properly positioned to effectively detect other underground objects or is not otherwise functioning properly (self-diagnostic in many embodiments). In other words, altering the movement of the work tool 140 causes the sensor 160 to be positioned too far away to detect an object 142 and the operator is alerted to this situation.

Other screens may have arrows for increasing or decreasing the gain of the system, be customized, etc.

It will be appreciated that the foregoing description provides examples of the disclosed assembly and technique. Examples of detecting both above ground and below the ground objects have been given. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for avoiding objects, the method comprising:
transmitting a signal using a sensor of a machine,
the sensor being positioned in front of a work tool of the machine and along a direction of travel of the work tool or the machine,
the machine traveling along a path on a ground surface and the work tool is moving;
the sensor pointing toward the ground surface;
monitoring signals responsive to the signal transmitted using the sensor,
the signals being monitored using the sensor or a receiver separate from the sensor;
processing one or more of the signals to detect an object along the path;
comparing a distance, between the object and the work tool, to a threshold; and
at least one of:
altering a movement of the work tool based on comparing the distance to the threshold, or
altering a movement of the machine based on comparing the distance to the threshold.

2. The method of claim 1, wherein the object is an underground object, and
wherein monitoring the signals includes receiving a signal, reflecting from the underground object, responsive to the signal transmitted using the sensor.

3. The method of claim 1, wherein altering the movement of the work tool or altering the movement of the machine is based one or more of the following variables:
a distance of the machine to the object;
a rate of deceleration of the machine; or
a rate of deceleration of the work tool.

4. The method of claim 1, wherein altering the movement of the machine or altering the movement of the work tool is performed automatically.

5. The method of claim 1, wherein altering the movement of the work tool includes stopping the movement of the work tool or changing the position of the work tool relative to the ground,
and altering the movement of the machine includes stopping the movement of the machine.

6. The method of claim 1, wherein altering the movement of the work tool causes the sensor to be positioned too far away to detect an object, and
wherein the method further comprises causing an alert, indicating a position of the sensor, to be provided to the operator.

7. The method of claim 1, wherein transmitting the signal includes transmitting ground penetrating radar waves.

8. The method of claim 1, wherein the object is an underground object, and
wherein the method further comprises receiving a reflected signal, from the underground object, based on sending the signal.

9. The method of claim 8 further comprising analyzing the reflected signal, reflected received from an underground object, using one or more signal templates, to determine an appropriate action with respect to at least one of the machine or work tool.

10. A work tool collision avoidance system for a machine with a work tool, the system comprising:
a sensor;
a receiver; and
an electronic controller unit coupled to the sensor and the receiver, wherein the electronic controller unit is configured to:
cause the sensor to transmit a signal at a first time interval;
process a signal received by the receiver at a second time interval; and
alter the movement of the work tool or the movement of the machine after processing the signal received by the receiver.

11. The work tool collision avoidance system of claim 10, wherein the electronic controller unit is further configured to store a database with a range of signals that are capable of being sent out by the sensor or received by the receiver.

12. The work tool collision avoidance system of claim 11, wherein the electronic controller unit is further configured to determine if an underground object is present based on the signal received by the receiver.

13. The work tool collision avoidance system of claim 12, wherein the sensor comprises an array of sensors.

14. The work tool collision avoidance system of claim 13, wherein the array of sensors are antennas configured to emit ground penetrating waves and the electronic controller unit is further configured to alter the movement of the machine via the machine control system or to alter the movement of the work tool via the work tool control system if an underground object is detected.

15. The work tool collision avoidance system of claim 14 further comprising an output device that is in communication with the electronic controller unit and the electronic control unit is further configured to send a signal to the output device that displays an image of the underground object.

16. The work tool vision system of claim 15, wherein the electronic controller unit is further configured to store a database of received signal templates for various underground objects and to compare the received signal of the underground object to one or more received signal templates.

17. The work tool vision system of claim 16 wherein the electronic controller unit is further configured to indicate via the output device the type of underground object being detected.

18. The work tool vision system of claim 10 further comprising a work tool with the sensor positioned in front of the work tool and an input device that is communication with the electronic controller unit and the input device is configured to send a signal to the electronic controller unit to affect the functioning of the work tool collision avoidance system.

19. An electronic controller unit of a machine comprising:
a memory including computer executable instructions for detecting an object; and
a processor coupled to the memory and configured to execute the computer executable instructions, the computer executable instructions when executed by the processor cause the processor to:
sense a signal indicating the presence of an object; and
send a control signal to a machine control system or a work tool control system to alter the movement of the machine or the movement of the work tool.

20. The electronic controller unit of claim 19 wherein the sensed signal is a reflected ground penetrating radar signal, and the control signal is configured to stop the movement of the machine, or stop the movement of the work tool, or alter the direction of travel of the machine, or alter the position of the work tool relative to the ground.
